(19) United States
(12) Patent Application Publication
(10) Pub. No.: US 2006/0037149 A1
(43) Pub. Date: Feb. 23, 2006

(54) Enzymatic degradation of cotton fibers: effect of protein cross-linking and the use of degradation to characterize fibers of plant of different genetic background

(76) Inventor: Allen K Murray, Newport Beach, CA (US)

Correspondence Address: LINER YANKELEVITZ SUNSHINE AND REGENSTREIF, 1100 GLENDON AVENUE, 14TH FLOOR, LOS ANGELES, CA, 90024, US

(21) Appl. No.: 10/501,577

(22) PCT Filed: Jan. 10, 2003
(86) PCT No.: PCT/US03/00753

§ 371 Date: Aug. 23, 2005

Related U.S. Application Data
(60) Provisional application No. 60/340,937, filed on Oct. 30, 2001.

(51) Int. Cl. C11D 3/00

(52) U.S. Cl. 8/115.51

(57) ABSTRACT

Specific extraction of the oligomers from cotton fibers can be: achieved by a 24-hr incubation at 37° C. with trypsin, chymotrypsin, proteinase K or pepsin, followed by a second 24-hr incubation at 37° C. with cellulase (Trichoderma reesei) or β-glucosidase. Alternatively, samples were first subjected to cellulase or β-glucosidase treatment followed by the protease. The residual material is then treated with 0.5N HCI at 100° C. and the extracts analyzed. Fibers treated with cellulase: followed by protease disintegrated and appeared as a cloudy solution, while the fibers treated with protease followed by cellulase retained their structural identity. This analysis reveals striking differences between cotton fibers from different varieties with respect to their susceptibility to enzymatic degradation. This protocol can be used to identify biochemical characteristics, which can then be correlated with genetic markers for advances in plant breeding.

For the purposes of the United States application based on this application, the present application is a Continuation In Part of application Ser. No. 09/003,679, filed Jan. 7, 1998, which is a Continuation In Part of application Ser. No. 08/516,953, filed on Aug. 18, 1995, now issued as U.S. Pat. No. 5,710,047, Jan. 20, 1998; of U.S. Provisional 60/096,162, filed Aug. 11, 1998; and of U.S. Provisional Patent 60/106,001, filed Oct. 28, 1998, International Application No. PCT/US99/00368, filed Jan. 7, 1999, and International Application No. PCT/US01/12904, designating the United States, filed 20 Apr. 2001, of all of which are hereby incorporated by reference into this application. For the purpose of the present International Application and the United States Application based hereon, the present application is based on and claims priority from U.S. Provisional Application 60/340,937, filed on 10 Jan. 2002 and incorporated herein by reference.

### BACKGROUND OF THE INVENTION

This invention concerns a method of degrading fibers with specific enzymes and chemical means to characterize degradation products that are related to biosynthetic precursors for cell wall biosynthesis. In addition, the enzymatic interconversion of soluble precursors from immature fibers may also be used. The degradative profiles are different for fibers of different varieties that have different fiber properties. This analytical method can be used to assist plant breeding for fiber qualities.

Previously, work in by the present inventor identified glycan oligomers associated with cotton fibers, cotton fabric, wood and paper. Specifically, glycan oligomers complexed with protein have been extracted from cotton fibers (Murray, et. al., 2001). Based on this observation, specific extraction of the oligomers was attempted. Immature fibers (25 days post anthesis) were subjected to a 24-hr incubation at 37° C. with trypsin, chymotrypsin, proteinase K or pepsin, followed by a second 24-hr incubation at 37° C. with cellulase (Trichoderma reesei) or β-glucosidase. Alternatively, samples were first subjected to cellulase or β-glucosidase treatment followed by the protease. Oligomers were released from fibers by both proteases and cellulase. The residual material was then treated with 0.5N HCl at 100° C. and the extracts analyzed by HPAEC-PAD. Additional oligomers could be extracted from fibers subjected to protease first followed by cellulase, but no oligomers were obtained from the material subjected to the cellulase first followed by the protease. Fibers treated with cellulase followed by protease disintegrated and appeared as a cloudy solution, while the fibers treated with protease followed by cellulase retained their structural identity. Chymotrypsin was the most effective protease at releasing oligomers and degrading fibers. When mature fibers from opened bolls were subjected to the same cellulase followed by protease procedure; there was little effect. For this reason, the procedure was repeated. At the end of the second cycle, the fibers disintegrated and only a fine particulate precipitate remained. This precipitate was washed, and digested in either 0.5N HCl, 2N trifluoroacetic acid or 6N HCl at 100° C. Degradation only occurred in 6N HCl, indicative of crystalline cellulose. The resulting monosaccharide composition was at least 99% glucose. The cellulase from T. reesei was compared to cellulase from T. viride (two sources) and cellulase form Aspergillus niger all of which were not effective in degrading intact fibers. However, the cellulase from T. viride completely degraded the isolated oligomers. Mature fibers from opened bolls were extracted with cold water and the extract was removed.

Recent experiments have revealed striking differences between cotton fibers from different varieties, which have differences in fiber quality, with respect to their susceptibility to enzymatic degradation as described here. This degradation protocol by specific enzymatic challenge can be quantified and rigorously defined. Use of this protocol applied to fibers of different varieties and different fiber qualities can be used to identify biochemical characteristics, which can then be correlated with genetic markers for advances in plant breeding.

The objective of this invention is to facilitate correlation of fiber structure at the biochemical level with fiber quality measurements that can be used to facilitate breeding for improved fiber quality. This information can then be used to provide insight to the mechanism(s) by which various factors affect fiber quality through environmental and/or genetic means. Cotton fibers are very complex cellular structures which, at maturity, consist of a waxy cuticle outside a primary cell wall surrounding a secondary cell wall which, in turn, surrounds a lumen containing the remnants of the living cell. The secondary cell wall is quantitatively the major component by far. The secondary wall is primarily made up of cellulose but also contains important constituents of proteins, lipids, glycoproteins, glycolipids and nucleic acids. The cellulose content can be an issue of discussion depending on one's definition of cellulose. No doubt the cotton fiber consists of greater than 90% β-1,4-glucan, however, the discrepancy may occur to determine the degree of crystallinity or what proportion of the β-1,4-glucan is crystalline. There is disagreement among investigators in the field about just what defines cellulose but the one thing they agree on is that it must have the crystal structure of at least two cellobiosyl units side by side. Therefore cellulose requires more than one β-1,4-glucan side by side. The biochemical composition and changes of constituents during development of Gossypium hirsutum L. Acala SJ-1 was reported by Meinert and Delmer (1977). However, chemical compositional analysis is only the beginning since it may not provide information on the organization of constituents. One approach to increase our understanding of cotton fiber wall structure is to degrade fibers in a stepwise manner using as gentle a means as possible yet as specific as possible employing enzymes of known specificity in a stepwise manner. This approach yields more information about the fiber organization than harsh chemical degradation. A combination of enzymatic and chemical methods has been used to analyze cotton fibers.

One approach to the genetic improvement of cotton fiber quality employs the use of quantitative trait loci (QTLs) associated with agronomic and fiber traits of upland cotton and genetic mapping (Shappley, et. al., 1998, Ulloa and Meredith, 2000, Burr, et. al., 2000). A number of fiber specific genes have been identified and have been expressed in model systems (Burr et al.; http://demeter.bio.bnl.gov). To date, there are no specific biochemical correlates to fiber quality properties such as strength, maturity and micronaire. Certainly, cellulose content and the degree of crystallinity must be factors but their organization has not been correlated with fiber measurements. The development of transgenic cotton plants which overexpress specific enzymes or proteins has provided some interesting clues which may lead to a better understanding of the fiber wall structure. Haigler and Holaday, 2002, have over expressed sucrose phosphate synthase (SPS) in transgenic cotton plants which increased the available sucrose pool for biosynthetic activities. The result was improved fiber quality including fiber strength and fiber length. Ruan et al., 2002, report the modulation of fiber quality by modifying the expression of sucrose synthase. Allen et al., 2002, have overexpressed a xyloglucantransferase and a peroxidase in transgenic cotton plants resulting in increased fiber strength and length. The presumed mechanism is that the increased xyloglucan transferase facilitated fiber during the elongation stage of primary cell wall synthesis. The xyloglucan chains are thought to cross-link the cellulose microfibrils. The peroxidase is thought to facilitate lignin biosynthesis but there is little, if any, lignin in the cotton fiber secondary wall. Both of these cases of the development of transgenic cotton plants resulting in changes in fiber quality suggest that a specific change, in the case of the xyloglucan transferase, or an increase early in a biosynthetic pathway may have significant effects on fiber quality as would be expected. It would be of great interest to analyze the structures of the fibers in both of these cases.

The cotton industry relies a great deal on the measurement of micronaire yet it is not at all clear what biochemical and cellular processes contribute to this measurement and in what manner. It is also not clear just what biochemical characteristics contribute to fiber strength in a specific manner. Clearly, the overall fiber properties must be the result of biochemical characteristics such as the degree of polymerization of the β-1,4-glucan chains, the degree of cross-linking, the degree of crystallinity of the cellulose and the linkages between the polysaccharide constituents with the protein and lipid constituents. As is the case with all materials, the properties of the material are determined by its molecular structure.

The molecular genetic approach to fiber improvement is to identify genes associated with fiber development, then attempt to express these genes in model systems and assess their effects on fiber properties. A major impediment to understanding the operation of fiber genes has been that little is known about the biochemical pathway of fiber and cellulose assembly. For this reason, the direct application of gene-expression techniques to fiber development is likely to produce results that are difficult to interpret, since there are no biochemical markers to assess effects of the expressed genes. This is unlike other areas of molecular genetics where is it possible to monitor various enzymes and biochemical intermediates that make up a known biochemical pathway. For these reasons, it is important to characterize cotton fiber wall structure at the biochemical level.

In previous applications the present inventor described his surprising discovery that it is possible to extract a carbohydrate-containing fraction from properly prepared plant material by a simple cold water process. Essentially, plant tissue is prepared by rapid freezing (preferably by use of liquid nitrogen or solid carbon dioxide) and is then lyophilized and stored at temperatures below freezing. As disclosed in the above-referenced parent applications carbohydrate-containing cell wall fractions can be easily extracted from the lyophilized tissue by cold aqueous extraction; then, special techniques of High Pressure Liquid Chromatography (HPLC) allow resolution of the aqueous extract into constituent mono and poly-saccharides which can be further hydrolyzed to identify the constituent monosaccharides.

The use of high pH anion exchange chromatography with pulsed amperometric detection (HPAEC-PAD) makes possible the unambiguous identification of cell wall constituents. In HPAEC a salt gradient (such as a sodium acetate gradient) is applied to a column of special ion exchange resins held at a high pH to sequentially elute various mono and poly-saccharides. Essentially, the hydroxyl groups of the sugars act as extremely weak acids that become deprotonated at the high pH, binding to the ion exchange matrix until eluted by the gradient.

While there are a number of vendors of HPAEC materials, the current invention has employed products and systems produced by the Dionex Corporation of Sunnyvale, Calif. These products and systems are explained in full in the Dionex Technical Notes, particularly in Technical Notes 20 and 21, which are hereby incorporated into this application. The carbohydrate fractions isolated from plant cell walls were analyzed using Dionex CarboPac PA1 and PA-100 columns. Both of these columns contain polystyrene/divinylbenzene cross-linked latex microbeads (350 nm diameter) with quaternary amine functional groups. The columns were operated under the manufacturer's recommended pressure conditions (4000 psi maximum) in sodium hydroxide eluted with a sodium acetate elution gradient. When necessary, sugar alcohols were analyzed using a CarboPac MA1 column that contains porous beads (8.5 μm diameter) of vinylbenzene chloride/divinylbenzene with alkyl quaternary ammonium functional groups

The polysaccharides analyzed in the present invention are appropriately referred to as “glycoconjugates” because they comprise a monosaccharide conjugated to at least one additional monosaccharide (i.e., to form an oligo or polysaccharide) and optionally to a protein or a lipid. As will be disclosed below at least some of the glycoconjugates comprise polysaccharides conjugated to a protein moiety. To summarize, glycoconjugates may be polysaccharides, polysaccharides containing a protein moiety, polysaccharides containing a lipid moiety and/or any combination of these. In the present application only polysaccharides and polysaccharides containing a protein moiety have been unambiguously identified. In any case HPAEC characterizes the polysaccharide component of the glycoconjugate.

### SUMMARY OF THE INVENTION

Previously, the inventor identified glycan oligomers associated with cotton fibers, cotton fabric, wood and paper. Specifically, glycan oligomers complexed with protein have been extracted from cotton fibers (Murray, et. al., 2001). Based on this observation, specific extraction of the oligomers was attempted. Immature fibers (25 days post anthesis) were subjected to a 24-hr incubation at 37° C. with trypsin, chymotrypsin, proteinase K or pepsin, followed by a second 24-hr incubation at 37° C. with cellulase (Trichoderma reesei) or β-glucosidase. Alternatively, samples were first subjected to cellulase or β-glucosidase treatment followed by the protease. Oligomers were released from fibers by both proteases and cellulase. The residual material was then treated with 0.5N HCl at 100° C. and the extracts analyzed by HPAEC-PAD. Additional oligomers could be extracted from fibers subjected to protease first followed by cellulase, but no oligomers were obtained from the material subjected to the cellulase first followed by the protease. Fibers treated with cellulase followed by protease disintegrated and appeared as a cloudy solution, while the fibers treated with protease followed by cellulase retained their structural identity. Chymotrypsin was the most effective protease at releasing oligomers and degrading fibers. When mature fibers from opened bolls were subjected to the same cellulase followed by protease procedure, there was little effect. For this reason, the procedure was repeated. At the end of the second cycle, the fibers disintegrated and only a fine particulate precipitate remained. This precipitate was washed, and digested in either 0.5N HCl, 2N trifluoroacetic acid or 6N HCl at 100° C. Degradation only occurred in 6N HCl, indicative of crystalline cellulose. The resulting monosaccharide composition was at least 99% glucose. The cellulase from T. reesei was compared to cellulase from T. viride (two sources) and cellulase form Aspergillus niger all of which were not effective in degrading intact fibers. However, the cellulase from T. viride completely degraded the isolated oligomers. Mature fibers from opened bolls were extracted with cold water and the extract was removed.

Recent experiments have revealed striking differences between cotton fibers from different varieties, which have differences in fiber quality, with respect to their susceptibility to enzymatic degradation as described here. This degradation protocol by specific enzymatic challenge can be quantified and rigorously defined. Use of this protocol applied to fibers of different varieties and different fiber qualities can be used to identify biochemical characteristics, which can then be correlated with genetic markers for advances in plant breeding.

### DESCRIPTION OF THE FIGURES

FIG. 1. shows the effect of cellulase or β-glucosidase on isolated multimers; control is the isolated multimers without enzyme treatment.

FIG. 2. The effect of a highly purified cellulase (T. veride) on glycan oligomers from 18 DPA fibers which were precipitated by 80% n-propanol.

FIG. 3. The effect of a highly purified cellulase (T. veride) on glycan oligomers from 18 DPA fibers which were precipitated by 80% n-propanol.

FIG. 4 shows the carbohydrates extracted from the first incubation of fibers treated with protease first (chymotrypsin) or cellulase first; PMSF=phenylmethylsulfonyl fluoride, a serine protease inhibitor.

FIG. 5 shows the carbohydrates released from the second incubation of the fibers; the cellulase fibers had a first incubation with chymotrypsin and the chymotrypsin fibers had a first incubation with cellulase.

FIG. 6 shows the multimers extracted from the fibers following the two extraction of FIGS. 4 and 5; CT=chymotrypsin, PMSF=phenylmethylsulfonyl fluoride.

FIG. 7 shows the hydrolysis products of the white particle (presumably cellulose) left following the enzymatic digestions of FIGS. 4-6 and subsequent hydrolysis with 0.1N HCl for 30 min and 2N Trifluoroacetic Acid for 2 hr at 100° C.

FIG. 8. shows a chromatogram of the monosaccharides released from the white particles above (FIG. 10) after digestion in 6N HCl for 2 hours at 100° C.

FIG. 9 shows carbohydrates released by cellulase without cross-linking (1) or following cross-linking with either 125 mM (2) or 250 mM (3) carbodiimide.

FIG. 10 shows carbohydrates released by chymotrypsin after the cellulase alone treatment (1) or after cross-linking with either 125 mM (2) or 250 mM carbodiimide (3) and a cellulase treatment.

FIG. 11 shows carbohydrates released by a second cellulase treatment (following the first cellulase and chymotrypsin treatments) alone (1) or following cross-linking with either 125 mM (2) or 250 mM (3) carbodiimide.

FIG. 12 shows carbohydrates released by a second chymotrypsin treatment (following the first cellulase, chymotrypsin and second cellulase treatments) alone (1) or following cross-linking with either 125 mM (2) or 250 mM (3) carbodiimide.

FIG. 13 shows the absorbance at 280 nm of carbohydrates released by chymotrypsin indicate the presence of a protein or glycoprotein.

FIG. 14. shows the pattern of oligosaccharides released by various cellulases from 22 DPA cotton fibers. The peak at about 11 min is cellobiose but there are unresolved peaks on the leading and trailing edge of cellobiose.

FIG. 15. shows the pattern of oligosaccharides released by various cellulases from 44 DPA cotton fibers. The peak at about 11 min is cellobiose but there are unresolved peaks on the leading and trailing edge of cellobiose.

FIG. 16. shows the residual fibers, if present, (bottom) and the precipitate from the fourth incubation (second chymotrypsin) for cellulases from T. reesei at pH 4.5, unbuffered, unbuffered+PMSF, T. longibrachiatum at pH 4.5, unbuffered and Humicola insolens at pH 4.5 and unbuffered. These were mature, 56 DPA fibers.

FIG. 17. shows a flow chart for analysis of extracts obtained by enzymatic degradation of cotton fibers.

FIG. 18. The fibers remaining in the incubation tubes (lower row) and the precipitates in the extracts following centrifugation (upper row) for five varieties following the incubation with chymotrypsin which was the second incubation. Tubes 1-5 were incubated with the cellulase from Trichoderma longibrachiatum and tubes 6-10 were incubated with the cellulase from Trichoderma reesei. The varieties by tube were: 1 and 6 1986 G-2; 2 and 7 Stovepipe; 3 and 8 Tamcot HQ-95; 4 and 9; Paymaster Tejas; 5 and 10 Deltapine 90.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a method of characterizing plant fibers—especially cotton fibers.

Previously, the inventor identified glycan oligomers associated with cotton fibers, cotton fabric, wood and paper. Specifically glycan oligomers complexed with protein have been extracted from cotton fibers (Murray, et. al., 2001). Based on this observation, specific extraction of the oligomers was attempted. Immature fibers (25 days post anthesis) were subjected to a 24-hr incubation at 37° C. with trypsin, chymotrypsin, proteinase K or pepsin, followed by a second 24-hr incubation at 37° C. with cellulase (T. reesei) or β-glucosidase. Alternatively, samples were first subjected to cellulase or β-glucosidase treatment followed by the protease. Some of the oligomers were released from fibers by both proteases and cellulase. The residual material was then treated with 0.5N HCl at 100° C. and the resulting extracts analyzed by high pH anion exchange chromatography with pulsed amperometric detection (HPAEC-PAD). Additional oligomers could be extracted from fibers subjected to protease first followed by cellulase, but no oligomers were obtained from the residual material subjected to the cellulase first followed by the protease. Fibers treated first with cellulase followed by protease disintegrated, while the fibers treated first with protease followed by cellulase retained their structural identity. Chymotrypsin was the most effective protease at releasing oligomers and degrading fibers. When mature fibers from opened bolls were subjected to the same cellulase followed by protease procedure, there was little effect. For this reason, the digestion procedure was repeated. At the end of the second cycle, the fibers disintegrated and only a fine particulate precipitate remained. This precipitate was washed, and digested sequentially in 0.5N HCl, 2N trifluoroacetic acid and 6N HCl at 100° C. Actual digestion occurred only in 6 N HCl, and the resulting monosaccharides obtained appear a great excess of glucose however there are very small quantities of arabinose, galactose, mannose and several unidentified peaks. The cellulase from T. reesei was compared to cellulases from T. viride (two sources), Aspergillus niger, T. longibrachiatum and Humicola insolens. Only the cellulases from T. reesei and T. longibrachiatum were effective in degrading intact fibers yet the cellulase from T. viride completely degraded the isolated oligomers. Mature fibers from opened bolls were extracted with cold water and the extract was removed.

Enzyme Treatments

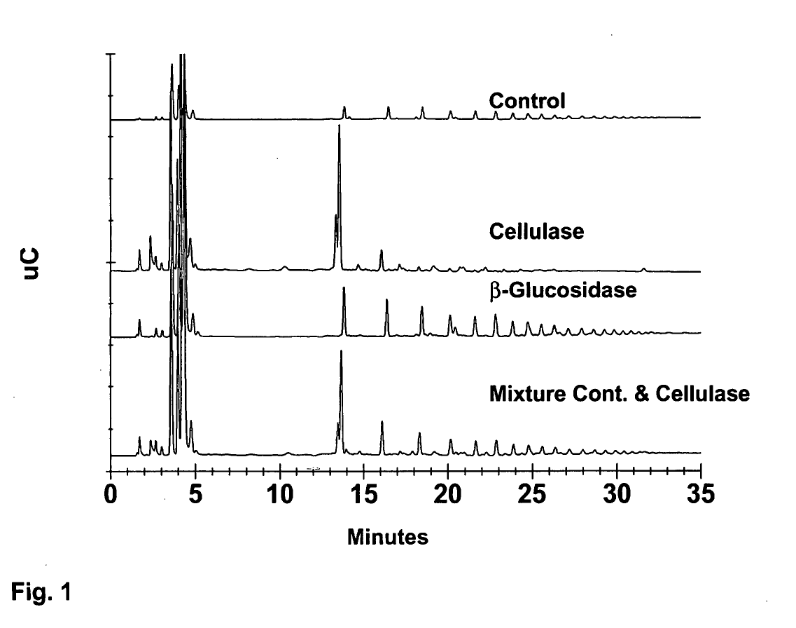

Extracted multimers were subjected to incubation with a cellulase (Trichoderma reesei) or a β-glucosidase (almond emulsin). The effect of the β-glucosidase appeared to be to increase the heights of the multimer peaks significantly and to generate one additional small peak with a retention time slightly greater than 20 min. Presumably this is the result of removing terminal glucose unit(s) that results in a compound with an increased detector response. The cellulase gave a very different result since it resulted in the near elimination of many peaks and great reductions in many peak heights with a great increase in the peak height of the first peak in the series of multimers as shown in FIG. 1.

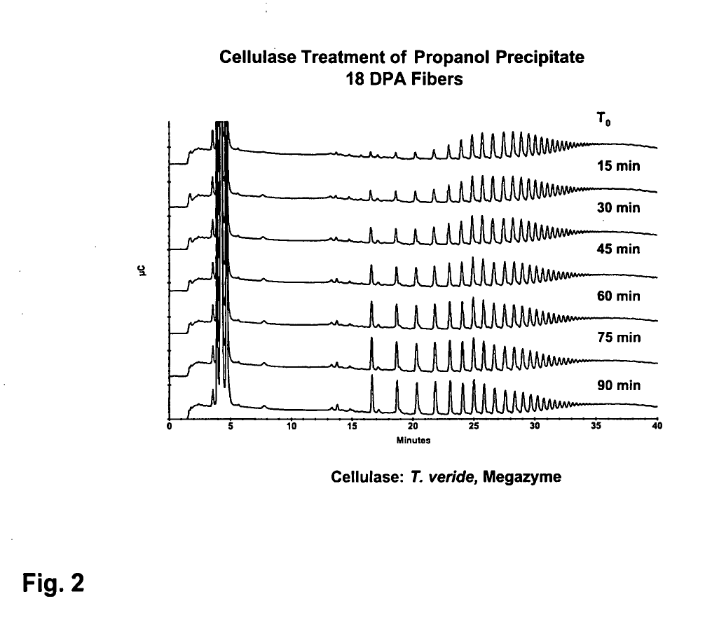

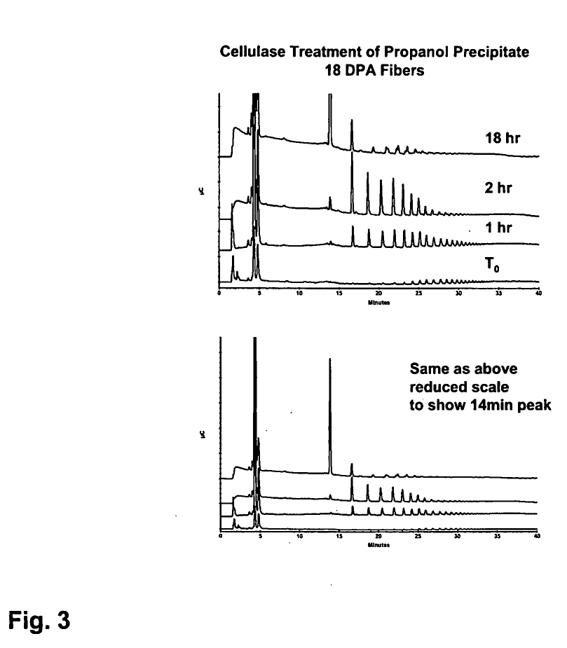

FIG. 1. shows the effect of cellulase (T. reesei) or β-glucosidase (almond emulsin) on isolated multimers; control is the isolated multimers without enzyme treatment. The reader's attention is also drawn to FIG. 2. which shows the effect of a highly purified cellulase (T. veride) on glycan oligomers from 18 DPA fibers which were precipitated by 80% n-propanol and to FIG. 3. which shows the effect of a highly purified cellulase (T. veride) on glycan oligomers from 18 DPA fibers which were precipitated by 80% n-propanol.

Based on the results of the treatment of the isolated multimers with enzymes, it was decided to attempt to modify the multimers in situ by subjecting the fibers to a sequential enzyme treatment. The goal was to be able to specifically remove the multimers by the chemically gentle and specific enzymatic means. If this could be accomplished then one could make a cogent argument for the multimers as specific components of the fiber cell wall. Fibers (25 DPA) were subjected to a 24 hr incubation with trypsin, chymotrypsin, proteinase K or pepsin followed by a second 24 hr incubation at 37° C. with cellulase or β-glucosidase. Alternatively, a duplicate set of samples was subjected to the same enzymes but in the reverse order. That is the cellulase or β-glucosidase first and then the protease second. The final fiber/residual material was then subjected to the dilute acid extraction to remove the multimers prior to HPAEC-PAD.

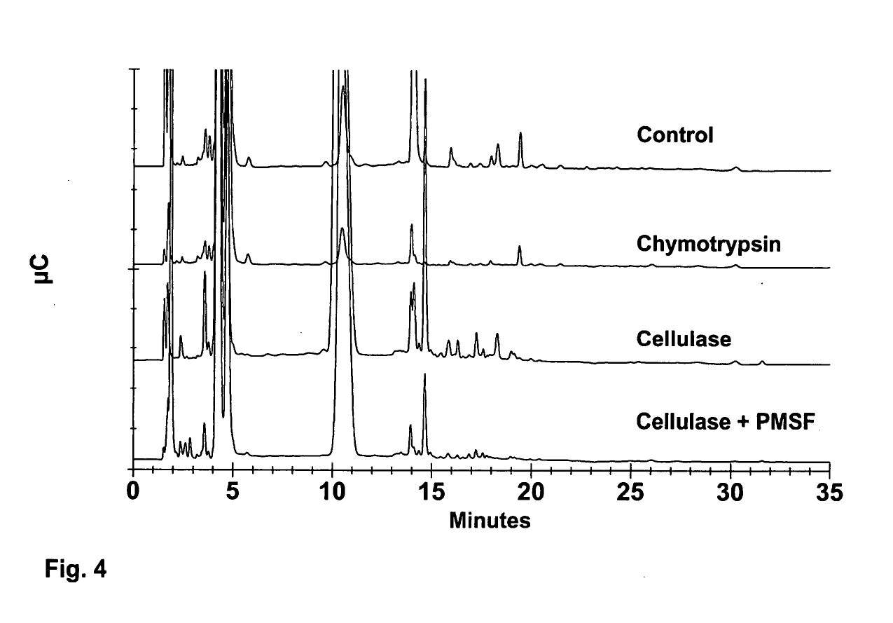

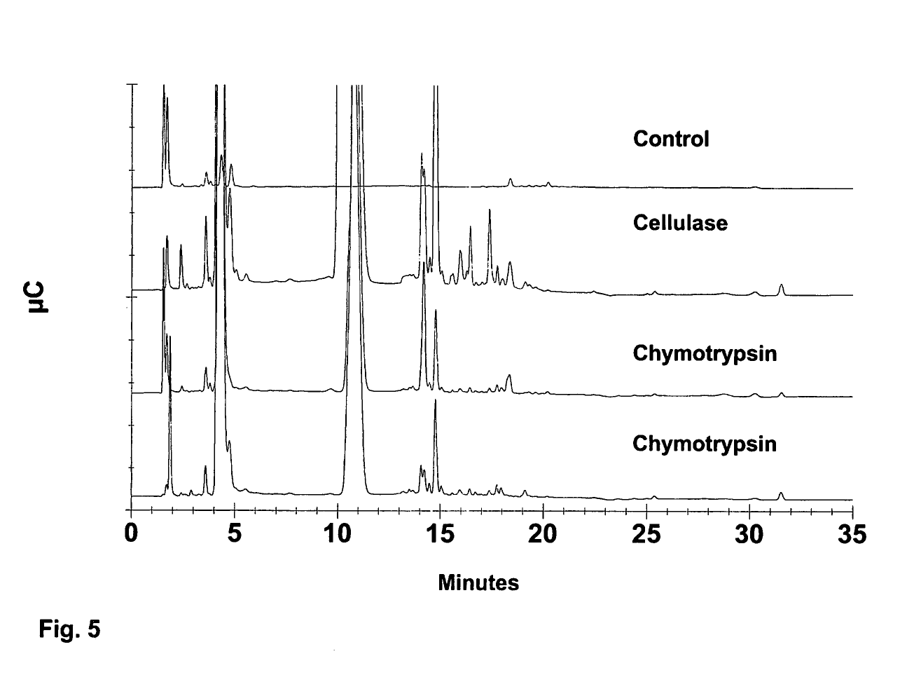

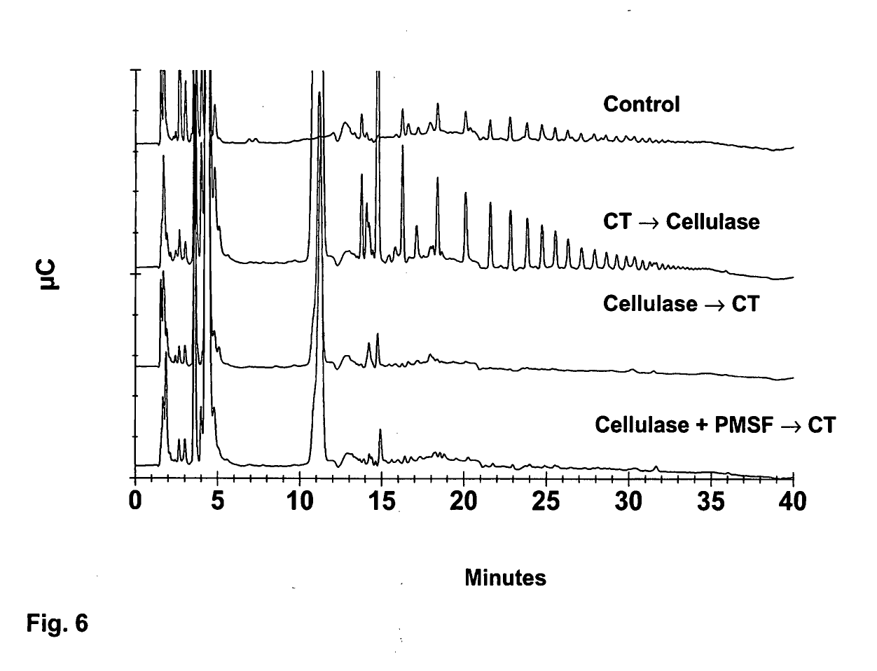

As shown in FIGS. 4-6, material was released by both proteases and cellulase. The multimers extracted from the final residual material (FIG. 6) indicate that multimers could be extracted from the control fibers or fibers subjected to protease first followed by cellulase, but no multimers were obtained from the material subjected to the cellulase first followed by the protease. In that case chymotrypsin was the most effective protease just as it was for degradation of the glue. However, the most striking observation was that the fibers treated with cellulase followed by protease lost their structural integrity and simply fell apart or were sucked up into the Pasteur pipette when the extract was removed.

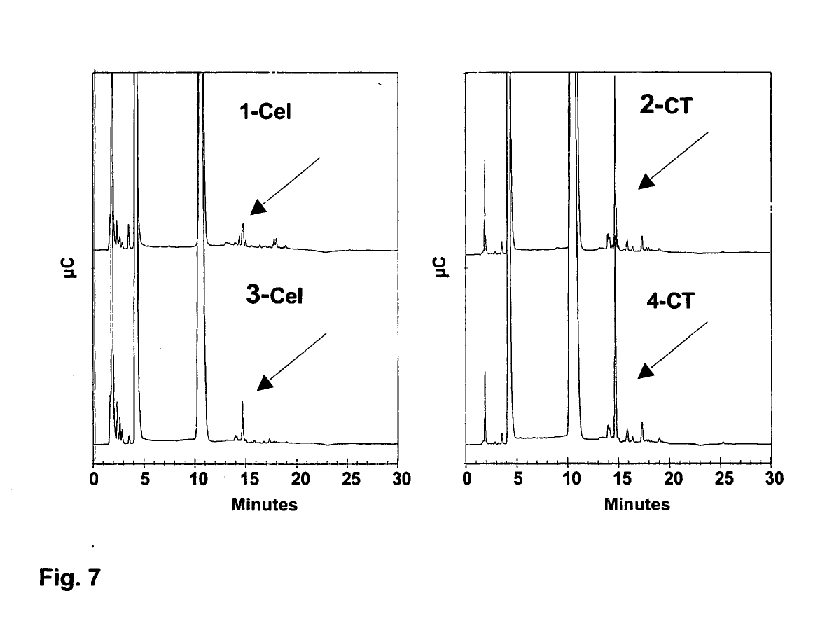

When mature fibers from opened bolls were subjected to the same cellulase followed by protease procedure, very little happened so the procedure was repeated a second time. FIG. 7. shows the HPAEC-PAD chromatograms of the extracts of the cellulase 1, chymotrypsin 1, cellulase 2, chymotrypsin 2 of mature fibers. Note the peak at 15 min which is much greater quantitatively in the chymotrypsin extracts. At the end of the second cycle, the fibers completely lost their structural integrity and only a precipitate of very small particles remained. These particles were then washed, subjected to digestion either in dilute HCl, in 2N trifluoroacetic acid or in 6N HCl. Actual digestion occurred only in 6 N HCl, and the resulting monosaccharides obtained appear to be in excess of 99% glucose; however there are small quantities of arabinose, galactose, mannose and several unidentified peaks This indicates that sequential treatment with cellulase followed by protease is an excellent method for producing cellulose of extremely high purity. This result is striking since it provides evidence for significant modification of the fiber walls associated with boll opening and maturity. This means that even though the cellulosic fiber wall is deposited in daily growth layers, there is obviously a very significant post-depositional modification process that drastically alters the fiber wall properties.

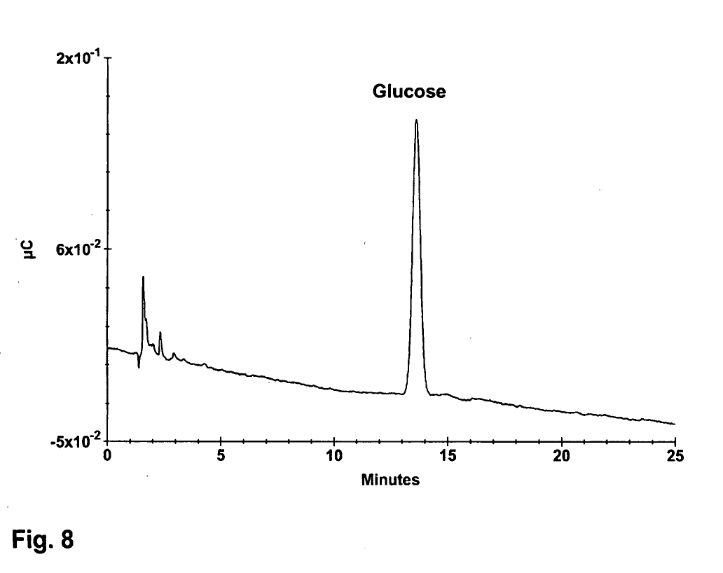

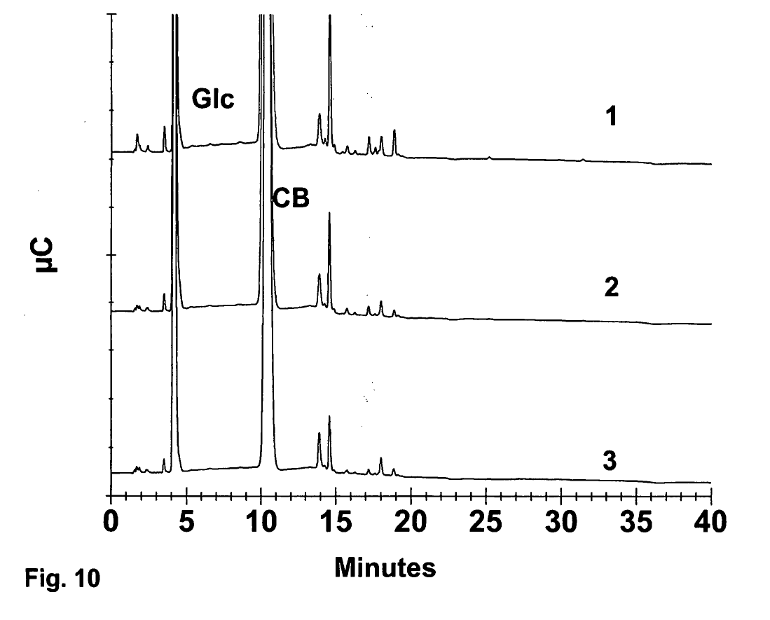

FIG. 8. shows a chromatogram of the monosaccharides released from the white particles of FIG. 10 after digestion in 6N HCl for 2 hours at 100° C. Note that the released sugar is essentially exclusively glucose, thereby confirming that the particles are essentially pure cellulose.

Oligomer Protein Complex and Cross-Linking

The probability that cellulose microfibrils of the plant cell wall are embedded in a matrix that “glues” them together has been proposed by a number of investigators over the years. The nature of such a protein oligomer complex has been the subject of considerable discussion but there has been no characterization of such a matrix material. The presence of cell wall subunits, in cotton fibers, was proposed by W. Lawrence Balls (Balls, W. Lawrence, 1928, Studies of Quality in Cotton, Macmillan & Co., London.) The present work (see above) on the cell wall “glue” matrix is an extension of work in my laboratory to characterize soluble oligosaccharides and the sucrosyl oligosaccharides in particular which appear to be involved in developmental changes of the cotton fiber.

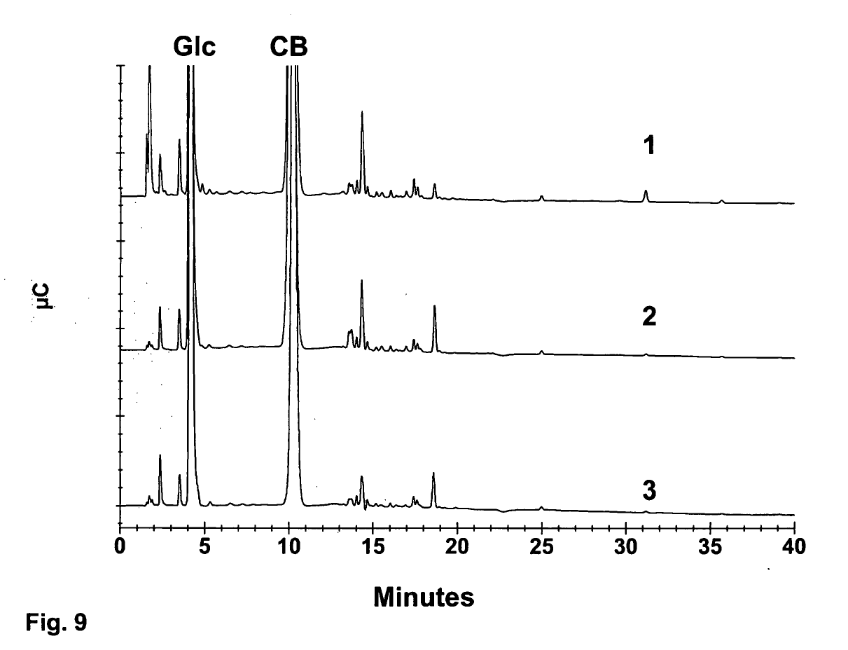

Mature fibers from opened bolls were extracted with cold water and the extract was removed. Cross-linking was then accomplished using water-soluble carbodiimide in unbuffered water at a pH of between 5.0 and 5.2. Two concentrations of water-soluble carbodiimide were used, 125 mM and 250 mM. The cross-linking reaction was carried out for 2 hr at room temperature followed by overnight at 4° C. The reaction mixture was washed from the fibers and the enzymatic digestion then ensued. The fibers were incubated with cellulase (T. reesei) (1 mg/ml) for 24 hrs followed by chymotrypsin (CT) (1 mg/ml) and the incubation sequence was then repeated. The results are shown in FIGS. 9-12. In all cases, samples number 1 are the controls; number 2 are the fibers from the 125 mM water soluble carbodiimide reaction and number 3 are the fibers from 250 mM carbodiimide reaction. Under the reaction conditions the carbodiimide would be expected to promote amide bond formation between amino acids while having negligible effect on ester bond formation between carbohydrates.

As explained above, a series of multimers (oligomers) can be extracted from developing cotton fibers by both chemical and enzymatic methods. These multimers have retention times of 14 minutes and greater under the analysis conditions employed. The regular spacing of the peaks is indicative of a series of oligosaccharides varying by a unit monomer in size. These results indicate that the multimers are heteropolymers with a repeating glucan unit extending from a core structure which is possibly a peptidoglycan. Above it was shown that the structural integrity of 25 DPA cotton fibers can be degraded by a sequential enzymatic treatment with a cellulase followed by a protease whereas the reverse extraction sequence does not result in complete degradation. When fibers from bolls that have opened are subjected to the same extraction sequence, they do not lose their integrity unless the process is repeated a second time. Following the second protease treatment, the fibers disintegrate into a white particulate precipitate.

Quantitatively the constituents released by enzymatic treatments consist mainly of glucose (Glc) and cellobiose (CB). Carbohydrates released by the first cellulase treatment are shown in FIG. 9 which demonstrates that carbodiimide at either concentration dramatically reduced the amount of glucose or cellobiose released by the cellulase treatment. The peak at 3.5 min retention time is arabinose. Many more of the peaks in the 14-20 min range are released by the cellulase from the control fibers than from the treated fibers. The major peak with a retention time of approximately 14.5 min released from the control fibers has a distinctly shorter retention time than the major peak at about 14.65 min released from the treated fibers. This is a significant difference and it only is demonstrable in the first cellulase extract.

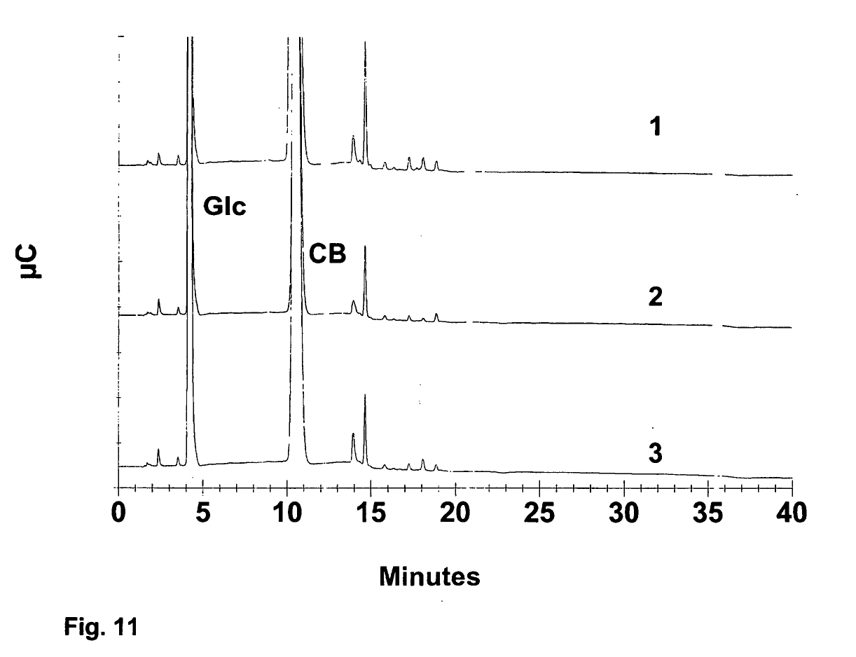

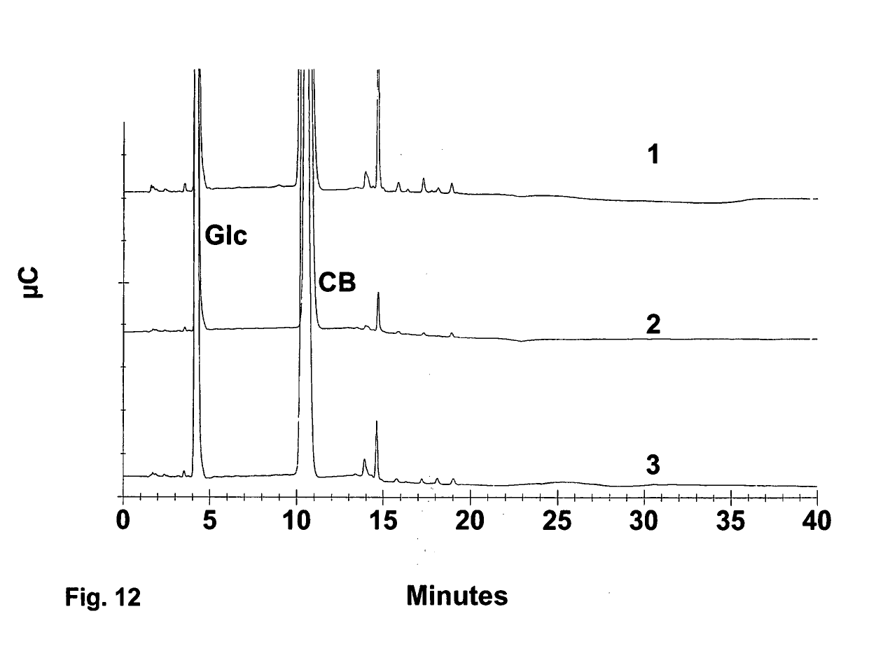

The carbohydrates released by the first chymotrypsin treatment are shown in FIG. 10. More peaks in the 14-20 min range are released from the control fibers than the treated fibers in addition to the large amounts of glucose and cellobiose released from both treated and controls fibers. This pattern is consistent for the carbohydrates released by the “second” cellulase treatment (actually a cellulase treatment following a chymotrypsin treatment) (FIG. 11) and “second” chymotrypsin treatment (actually a chymotrypsin treatment following a cellulase treatment)(FIG. 12).

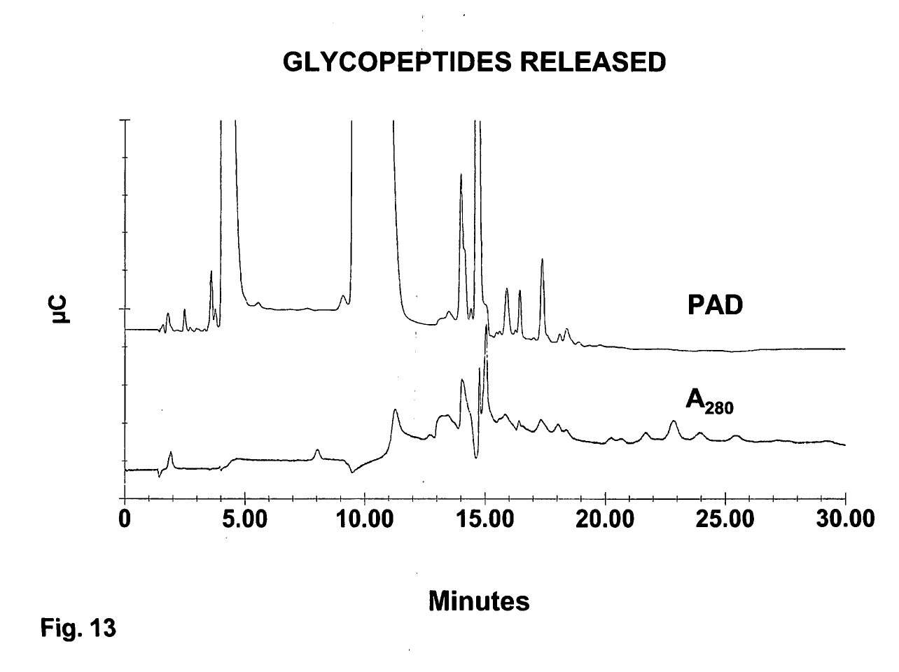

The carbohydrate peaks released with retention times between 14 and 20 minutes also contain a constituent, which absorbs at 280 nm as shown in FIG. 13. The absorbance at 280 nm is usually due to the phenolic amino acids phenylalanine and tyrosine in proteins although other compounds may also absorb at 280 nm. Based on this result along with the material released by the proteases, it is concluded that the carbohydrate peaks in this 14-20 min range are glycoproteins. The observation that linking with a carbodiimide renders these carbohydrates more resistant to the protease release further substantiates the conclusion that they are, in fact, glycopeptides. The discovery that the protease digestion significantly increases the release of glucose and cellobiose confirms that the cellulosic constituents of the wall are cross-linked by a protease sensitive component (i.e., a protein or glycoprotein).

As detailed above, I have been able to obtain the multimers from a large molecular complex that is secreted by fibers, in vitro, by a temperature dependent mechanism. The relative distribution of the multimers can vary depending on the exogenous substrates incubated with the fibers and on the time of day that the bolls were collected. Under optimal conditions I have demonstrated the presence of the multimers in an initial soluble fraction, a secreted fraction which will not pass through a 0.2 μm filter, the precipitate of the aqueous extract and the fibers themselves. The multimers appear to play a structural role in the integrity of the cotton fiber since experiments to extract the multimers using specific enzymes resulted in a striking loss of the physical integrity of the cotton fibers.

The experiments just described demonstrate the A₂₈₀ profile of the material released by the sequential treatment of mature cotton fibers with cellulase, chymotrypsin, cellulase and then chymotrypsin again. These profiles indicate that the multimers are probably attached to protein. When the fibers are treated with a water-soluble carbodiimide to form amide bonds between the carboxyl and amino groups of the amino acid constituents, the fibers become more resistant to enzymatic degradation. This result shows that bifunctional reagents have applications in the textiles and lead to ways to improve the quality (e.g., durability) of cotton fabric. In previous work I have shown that normal cotton textiles continually shed water-soluble multimers over the life of the fabric. This suggests that fabric wear is at least partially due to loss of soluble material during washing. Chemical cross-linking is a way to reduce this loss and, thereby, extend the life of cotton fabrics. Although this test employed carbodiimide any of a large number of bifunctional reagents known to react with amino groups can be used. These reagents are well known to a person of ordinary skill in the art of protein chemistry. The significant point is that my experiment is the first demonstration that protein cross-linking reagents are useful to alter properties of cotton and other plant-based textiles.

Crystalline Cellulose

Hydrolysis experiments on the white particulate material which remains following the enzymatic digestion of the fibers is consistent with these particles being perhaps very highly crystalline cellulose. This result is consistent with the prediction by Balls (1928) that the fiber wall is made up of little domino or brick-like structures which are held together and permit the fiber to be flexible. It is probable that the material that holds the “bricks” together is the “glue” matrix described in part here with the multimers attached to a protein backbone. This result is consistent with the fact that plant breeders directly select for varieties with different fiber properties including strength. It is likely that a matrix protein is a primary gene product while a polysaccharide, such as cellulose, is the product of a number of enzymes which, in turn, are the products of a number of genes. Thus, direct selection and manipulation by genetic engineering should be more successful on the matrix protein than on the complex of enzymes needed to synthesize cellulose.

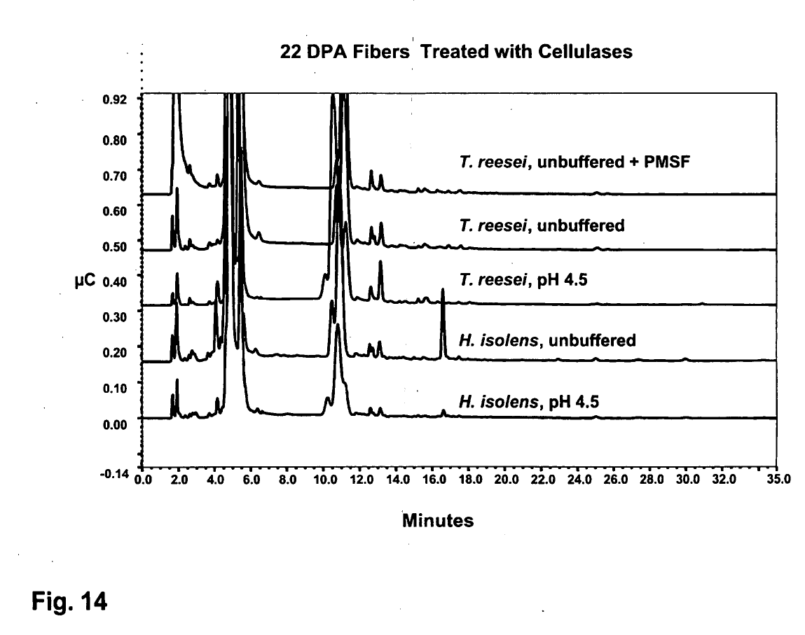

In addition to the T. reesei cellulase, several other cellulases have been used to digest cotton fibers. To date, only two cellulases (T. reesei and T. longibrachiatum) have demonstrated the ability to render the fibers susceptible to degradation by the proteases. At this time, it is not known if this “activity” could be due to a contaminating protease, a contaminating glycosidase or some other factor inherent in the enzyme preparation. Differences have been noted between the various cellulases as far as the intermediate oligosaccharides released. All of the cellulases are characterized by their sources on the basis of glucose released from a cellulosic substrate per unit time under standard conditions. These characterizations have all been found to be accurate. However, the cellulases differ markedly in their intermediates as is shown in FIGS. 13 and 14.

FIG. 14. shows the pattern of oligosaccharides released by various cellulases from 22 DPA cotton fibers. The peak at about 11 min is cellobiose but there are unresolved peaks on the leading and trailing edge of cellobiose. (The peak at the leading edge of cellobiose has also been seen in this laboratory in biosynthetic experiments. The peaks from both experiments co-chromatograph.)

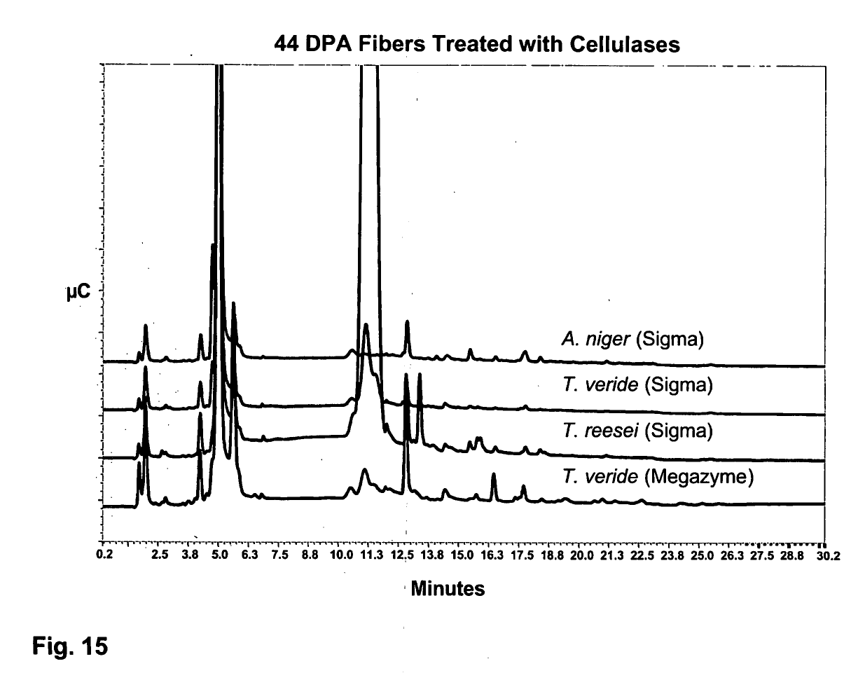

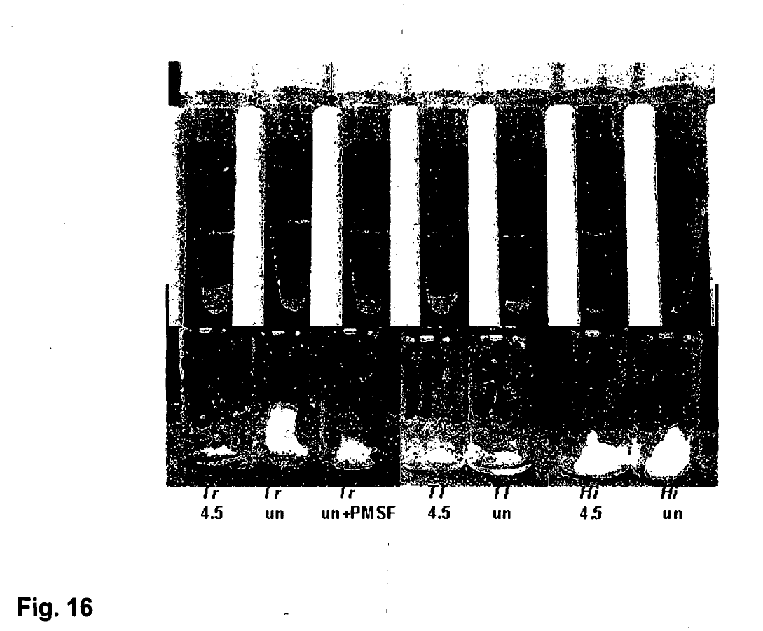

FIG. 15. shows the pattern of oligosaccharides released by various cellulases from 44 DPA cotton fibers. The peak at about 11 min is cellobiose but there are unresolved peaks on the leading and trailing edge of cellobiose. FIG. 16. shows the residual fibers, if present, (bottom) and the precipitate from the fourth incubation (second chymotrypsin) for cellulases from T. reesei at pH 4.5, unbuffered, unbuffered+PMSF, T. longibrachiatum at pH 4.5, unbuffered and Humicola insolens at pH 4.5 and unbuffered. These were mature, 56 DPA fibers.

To date the following cellulases have been compared using 50 DPA fibers:
1. Aspergillis niger (Sigma):
2. Trichoderma veridie (Sigma),
3. Trichoderma veridie (Megazyme), Humicola isolens (Fluka),
5. Trichoderma reesei (Sigma) Trichoderma veridie (Fluka),
7. Trichoderma reesei (Fluka), Trichoderma longibrachiatum (Fluka).

Of these cellulases tested, only Trichoderma reesei (Sigma) and Trichoderma longibrachiatum (Fluka) rendered the fibers susceptible to protease degradation. The fact that different cellulases released different oligosaccharides and that the same cellulase released different oligosaccharides under different pH conditions may not be terribly surprising and, in fact, may be useful to the characterization of cotton fibers from different varieties. The fact that the T. reesei and T. longibrachiatum cellulases are the only ones which rendered the fibers susceptible to the protease may be due to the presence of swollenin (Saloheimo, et. al., 2002 and Swanson, et. al., 2002) which is a protein which disrupts cellulose fibril structure but does not cleave glycosidic bonds.

In all cases, an attempt was made to use equivalent amounts of cellulase in all incubations. This was done by comparing the specific activity of each cellulase as stated by the supplier on the label of the bottle. In all cases, the activity is based on glucose or reducing sugar released from a known substrate of SigmaCel 20 or carboxymethylcellulose. Based on the results obtained, it is obvious that it is not valid to compare the different cellulases based on the glucose or reducing sugar released. Clearly, different intermediate products are released along the pathway between the macromolecular substrate and glucose.

There is a large body of literature dealing with the action of cellulases on cotton fibers as well as other substrates. However, that work has been done on cotton fibers that have been subjected to processing treatments since the goal of most of that work is to facilitate fabric finishing and other applications in the textile industry. The majority of this recent work has been done using the endocellulase and cellobiohydrolase from Trichoderma reesei (Lee, et. al., 2000, Pere, et. al., 2001, Väljamäe, et. al., 2001) but the use of recombinant enzymes from Humicola insolens involved two cellobiohydrolases and one endocellulase (Boisset, et. al., 2001). In all of these studies the activities were assayed by measuring the end products, cellobiose or glucose and the intermediate products were not investigated. The possibility that these cellulases might also function as glycosyl transferases and may thus actually synthesize intermediates can not be overlooked in the light of reports of synthesis of β-lactosides by Trichoderma reesei cellulase (Totani, et. al., 2001).

Comparison of Enzymatic Degradation of Different Varieties

Fibers of different varieties have been subjected to the degradation protocol shown in FIG. 16. The results of the analyses can be compared to the genetic background of the varieties to determine if correlations can be made. The differences are clearly striking. It will be important to compare varieties which are more closely related genetically to determine just how little a difference maybe detected. One would assume that differences which are specific to the cell wall would be detectable in very closely related varieties while differences which are not specific to the cell wall, may not be as striking. To date, overnight incubations have been used due to the convenience and not knowing if shorter incubation periods may work just as well. To date all incubations have been at 37° C. with toluene layered over the mixture to inhibit microbial growth. However, some investigators have assayed cellulases at 45° C. It may also turn out that one temperature may be optimal for a cellulase and another may be optimal for a protease.

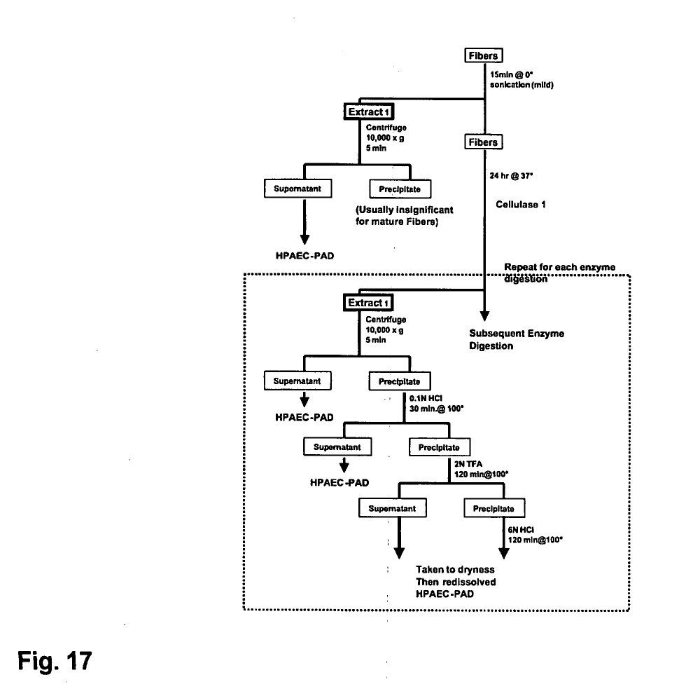

A flow chart for the analytical procedure is shown in FIG. 17 for one enzyme incubation. The area in the box indicated by the dotted line is then be repeated following each enzyme incubation. The constituents identified and quantified by HPAEC-PAD and entered into a balance sheet for comparison between varieties. Differences are detected between varieties. However, varieties compared must come from variety trials in the same field to rule out differences due environmental variation.

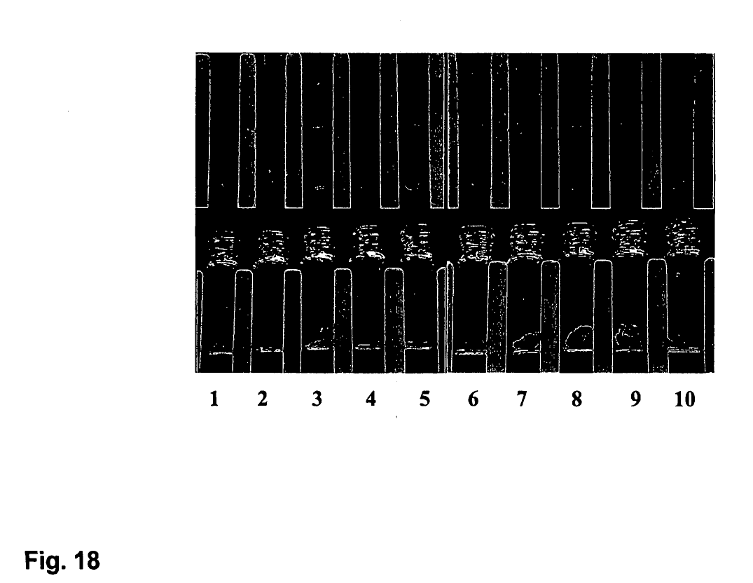

FIG. 18 shows the fibers remaining in the incubation tubes (lower row) and the precipitates in the extracts following centrifugation (upper row) for five varieties following the incubation with chymotrypsin which was the second incubation. Tubes 1-5 were incubated with the cellulase from Trichoderma longibrachiatum and tubes 6-10 were incubated with the cellulase from Trichoderma reesei. The varieties by tube were: 1 and 6 1986 G-2; 2 and 7 Stovepipe; 3 and 8 Tamcot HQ-95; 4 and 9; Paymaster Tejas; 5 and 10 Deltapine 90.

The dry mass of the precipitates released by each enzyme incubation can be determined. The oligosaccharides released can be quantified from chromatograms showing the sugars released by the enzyme treatment. The differences are clear but they are easily summarized in a more striking manner in the photograph of FIG. 18.

The rationale for the enzyme degradation experiments, as stated earlier, was to attempt to remove the glycan oligomer complex specifically with cellulases and proteases to determine it played a structural role. The fact that the fibers fall apart was a surprise and just adds further evidence for a structural role. The rationale for the comparative degradation experiments on different varieties of cotton is based on the differences in fiber properties. Clearly, fiber properties such as strength, micronaire and maturity are each the composite representation of a number of characteristics at the biochemical level. These characteristics may be the result of the total amount of cellulose, the manner in which the cellulose is complexed with protein or other wall constituents. The possible combinations of linkages, including β-1,3-glucans, β-1,4-glucans, arabinogalactans in cotton fiber walls (Bucheli, et. al., 1985, 1987, Buchala and Meier, 1981), all play critical roles in contributing to fiber strength, micronaire and maturity. When these factors are considered in the light of one report that the cotton fiber has acquired about 60% of its strength before the major contribution of secondary cell wall synthesis (Lewis and Benedict, 1994) the concept of the complexity of the cotton fiber wall is truly amazing. The number of gene products which contribute to the fiber wall clearly must be very large and encompasses precursors of proteins, lipids, glycoproteins, glycolipids as well as polysaccharides. The role of cellulases or β-glucanases in cellulose biosynthesis and cell wall biosynthesis is not understood but they are required and their role has recently been reviewed (Mølhøj, et. al., 2002) By systematic challenges to the biochemical integrity of the fiber wall and the resultant specific degradation, it is possible to characterize differences between fibers of differing quality at the biochemical level. Further, if this is done to different varieties grown under identical conditions, to rule out environmental differences, then this approach will facilitate the search for biochemical differences between different

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

### REFERENCES

Allen, R. D., Y. Kasukabe, I. Ihara, and Y. Maekawa, 2002, Cotton plants with improved fiber characteristics and method for producing cotton fibers from these cotton plants, U.S. Patent Application No. U.S. 2002/0049999 A1.
Boisset, C., C. Pétrequin, H. Chanzy, B. Henrissat and M. Schülein, 2001, Optimized Mixtures of Recombinant Humicola insolens Cellulases for the Biodegradation of Crystalline Cellulose, BIOTECHNOLOGY AND BIOENGINEERING 72: 339-345.
Buchala, A. J. and H. Meier, 1981, An Arabinogalactan From The Fibres Of Cotton (Gossypium arboreum L.), Carbohydrate Research 89:137-143.
Bucheli, P., A. J. Buchala and H. Meier, 1987, Aurolysis in viotro of Cotton (Gossypium hirsutum) Fibre Cell Walls, Physiol. Plantarum 70:633-638.
Bucheli, P., M. Dürr, A. J. Buchala and H. Meier, 1985, β-Glucanases in Developing Cotton (Gossypium hirsutum L.) Fibres, Planta 166:530-536.
Haigler, C. H. and A. S. Holaday, 2002, Transgenic cotton plants with altered fiber characteristics transformed with a sucrose phosphate synthase nucleic acid, U.S. Pat. No. 6,472,588 B1.
Liu, S., S. Saha, D. Stelly, B. Burr, and R. G. Cantrell. 2000. Chromosomal assignment of microsatellite loci in cotton. J. Heredity 91:326-32.
Lewis, H. L. and C. R. Benedict, 1994, Biochemistry of Cotton, Biochemistry of Cotton Workshop (Jividen, G. M. and C. R. Benedict, eds.) Galveston, Tex., pp 212-123.
Lee, I., B. R. Evans, J. Woodward, 2000, The mechanism of cellulase action on cotton fibers:evidence from atomic force microscopy, Ultramicroscopy 82:213-221.
Meinert, M. C. and Delmer, D. P., 1977, Changes in Biochemical Composition of the Cell Wall of the Cotton Fiber During Development, Plant Physiol. 59, 1088-1097.
Mølhøj, M, Pagant, S and H. Höfte, 2002, Towards Understanding the Role of Membrane-bound Endo-β-1,4-glucanases in Cellulose Biosynthesis., Plant Cell Physiol. 43(12): 1399-1406.
Murray, A. K., R. L. Nichols, and G. F. Sassenrath-Cole, 2001, Cell Wall Biosynthesis: Glycan Containing Oligomers in Developing Cotton Fibers, Cotton Fabric, Wood and Paper Phytochemistry, 57(6):975-986.
Peng, L., F. Xiang, E. Roberts, Y. Kawagoe, L. C. Greve, K. Kreuz and D. P. Delmer, 2001, The Experimental Herbicide CGA 325'615 Inhibits Synthesis of Cryastalline Cellulose and Causes Accumulation of Non-Crystaline β-1,4-glucan Associated with CesA Protein, Plant Physiol. 126:981-992.
Pere, J., A. Puolakka, P. Nousiainen and J. Buchert, 2001, Action of purified Trichoderma reesei cellulases on cotton fibers and yarn, Journal of Biotechnology 89:247-255.
Ruan, Y-L., R. Furbank, D. Llewellyn, 2002, Modification of sucrose synthase gene expression in plant tissue and uses therefore, U.S. Patent Application No. U.S. 2002/0116736 A1.
Saloheimo, M., M. Paloheimo, S. Hakola, J. Pere, B. Swanson, E. Nyyssönen, A. Bhatia, M. Ward and M. Penttilä, 2002, Swollenin, a Trichoderma reesei protein with sequence similarity to the plant expansins, exhibits disruption activity on cellulosic materials, Eur. J. Biochem. 269, 4202-4211.
Swanson, B. A., M. Ward, M. Penttilä, J. Pere, and M. Saloheimo, 2002, Microbial swollenin protein, DNA sequences encoding such swollenins and a method of producing such swollenins, U.S. Pat. No. 6,458,928 B1.
Totani, K., N. Yasutake, H. Ohi, T. Murata, and T. Usui, 2001, Enzymatic Synthesis of Aliphatic b-Lactosides as Mimic Units of Glycosphingolipids by Use of Trichoderma reesei Cellulase, Archives of Biochemistry and Biophysics 385:70-77.
Shappley, Z. W., J. N. Jenkins, J. Zhu, and J. C. McCarty, Jr., 1998. Cotton Improvement, Quantitative Trait Loci Associated with Agronomic and Fiber Traits of Upland Cotton, J. Cotton Science 2:153-163.
Ulloa, M. and W. R. Meredith, Jr., 2000. Breeding & Genetics, Genetic Linkage Map and QTL Analysis of Agronomic and Fiber Quality Traits in an Intraspecific Population, J. Cotton Science 4:161-170.
Väljamäe, P., G. Pettersson and G. Johansson, 2001. Mechanism of substrate inhibition in cellulose synergistic degradation, Eur. J. Biochem. 268, 4520-4526.

I claim:

1. A method of improving fabric properties comprising treating cotton fibers with a chemical reagent which forms covalent bonds with amino groups present within the fibers.

2. The method of claim 1, wherein the chemical reagent is a carbodiimide.

3. The method of claim 1, wherein the chemical reagent forms amide bonds.

4. A method of enzymatically degrading cotton fibers to yield essentially pure cellulose comprising the steps of sequentially treating the fibers first with cellulase and then with protease.

5. A method of characterizing cotton fiber cell walls comprising the steps of specific enzyme degradation in sequential steps utilizing cellulases and proteases.

6. The method of claim 5, wherein the cellulases are utilized at different pH's to accentuate differences between cotton fibers of different varieties.

7. The method of claim 5, wherein different types of proteases are utilized.

8. The method of claim 7, wherein the different types of proteases are utilized sequentially.

9. The method of claim 5, wherein different types of cellulases are utilized.

10. The method of claim 9, wherein different types of cellulases are utilized sequentially.

11. The methods of claim 5-10, further comprising the step of utilizing the characterization of cotton fibers according to the methods to develop biochemical markers for fibers of different cotton varieties.

12. The method of claim 11, wherein the biochemical markers are used in plant breeding to improve fiber quality.

13. The method of claim 11, wherein the biochemical markers are used as a means to distinguish varieties of cotton.
